(19) United States
(12) Patent Application Publication
(10) Pub. No.: US 2012/0320576 A1
(43) Pub. Date: Dec. 20, 2012

(54) Quick Installation Ballast

(76) Inventors: Brian Wald, Los Angeles, CA (US); Kevin Yang, Lomita, CA (US)

(21) Appl. No.: 13/160,267

(22) Filed: Jun. 14, 2011

(51) Int. Cl. F21V 7/00

(52) U.S. Cl. 362/217.09

(57) ABSTRACT

An end mounted ballast lighting fixture includes a reflector. The reflector is generally rectangular shaped. A ballast is mounted to the reflector and the ballast has a ballast housing has a pair of sections, namely a top ballast housing section and a lower ballast housing section. The lower ballast housing section is mounted to a side wall of the reflector. A pair of ballast sockets, namely a first ballast top face socket and a second ballast top face socket are mounted on a top face of the top ballast housing section. A pair of florescent light bulbs, namely a first florescent light bulb and a second florescent light bulb are mounted in the reflector. The top face faces toward the pair of florescent light bulbs.

### FIELD OF THE INVENTION

The present invention is in the field of ballast mounting configuration.

### DISCUSSION OF RELATED ART

Ballast have been mounted on a top or side of a housing for light fixture. A wide variety of light fixtures have been made for creating various configurations of ballast according to architectural needs.

For example, in U.S. Pat. No. 6,164,797 to Crane issued Dec. 26, 2000, the disclosure of which is incorporated herein by reference, the reference refers to a florescent lighting fixture utilizing a printed circuit board as an electronic ballast. The printed circuit board ballast includes outlet pins which are directly mounted and connected to the lamp holders, to minimize or eliminate a number of wires running between the ballast and lamp holders.

Many existing commercial lighting fixtures in the US have a size of 2′×4′ which is based on the SAE system (Foot, Pound and F. degree), and it is the most popular system in the United States market today. The T8 4′ lamp's length is 48 inches long which fits the 2′×4′ fixture. Most other countries such as in Europe, Canada and Asia (including Japan and China) use the Metric System (Meter, Kg and C degree). These counties' commercial standard lighting fixture is 120 cm×60 cm which is slightly shorter (about 2%) than the US's fixture. The T5 F28 or F54 lamps are designed for the Metric lighting fixtures, and therefore it is a bit shorter (about 2″) for the US existing lighting fixture. What is needed is an adapter that can adapt between the different sizes.

### SUMMARY OF THE INVENTION

An end mounted ballast lighting fixture for a T5 lamp includes a reflector. The reflector is generally rectangular shaped. A ballast is mounted to the reflector and the ballast has a ballast housing has a pair of sections, namely a top ballast housing section and a lower ballast housing section. The lower ballast housing section is mounted to a side wall of the reflector. A pair of ballast sockets, namely a first ballast top face socket and a second ballast top face socket are mounted on a top face of the top ballast housing section. A pair of florescent light bulbs, namely a first florescent light bulb and a second florescent light bulb are mounted in the reflector. The top face faces toward the pair of florescent light bulbs.

The first florescent light bulb is electrically connected to the first ballast top face socket, and the second florescent light bulb is electrically connected to the second ballast top face socket. An intermediate connector is formed as a flat strip having a first end and a second end. A pair of electrically connected socket connectors includes a first socket connector and a second socket connector both attached to the intermediate connector. The first socket connector and the second socket connector are connected in electrical series.

The ballast is placed to abut an inside surface of the reflector. The intermediate connector is mounted to abut the inside surface of the reflector. The ballast can be configured to snap into an inside surface of the reflector. The intermediate connector has the shape of a flat rail for snap in connection to the reflector. The ballast notch is disposed on the lower portion of the ballast on a ballast flange that extends from the ballast bottom face. The pair of ballast sockets each may include a ballast socket slot and a ballast socket housing. The ballast socket slot communicates with a ballast socket pivoting member that rotates inside the ballast socket housing so as to secure electrical leads of a lamp bulb within the pivoting member portion.

The ballast notch is disposed on the lower portion of the ballast on a ballast flange that extends from the ballast bottom face. The pair of ballast sockets each further include a ballast socket slot and a ballast socket housing. The ballast socket slot communicates with a ballast socket pivoting member that rotates inside the ballast socket housing so as to secure electrical leads of a lamp bulb within the pivoting member portion.

### BRIEF DESCRIPTION OF THE DRAWINGS

FIG. 1 is an exploded view of the present invention.

FIG. 2 is a second exploded view of the present invention showing an alternate angle.

FIG. 3 is a bottom view of the present invention, seen from the perspective of the viewer looking up at the ceiling where the light is mounted.

FIG. 4 is a ballast view of the present invention showing connection of the ballast to the lamp elements.

FIG. 5 is a intermediate connector view of the present invention showing the intermediate connection.

FIG. 6 is a close up view of the ballast.

The following call out list of elements references the elements of the drawings.
21 First Socket Connector
22 Second Socket Connector
23 Intermediate Connector
24 Reflector
31 First Bulb
32 Second Bulb
33 Ballast
34 Ballast Top Face
35 Ballast Bottom Face
36 First Ballast Top Face Socket
37 Second Ballast Top Face Socket
41 First Notch
42 Second Notch
51 Ballast Notch
52 Ballast Flange
61 Ballast Socket Slot
62 Ballast Socket Housing
63 Ballast Socket Pivoting Member

### DETAILED DESCRIPTION OF THE PREFERRED EMBODIMENT

The present invention is generally a florescent lighting fixture with an electronic ballast for T5 (⅝″ outer diameter) F28 or F54 lamp. The electronic ballast of the lighting fixture is approximately 2 inches high measured in the direction of the length of the bulb, such that the electronic ballast adds approximately 2 inches of length to a bulb assembly which comprises the bulb, sockets and ballast. The ballast and ballast sockets are approximately 2 inches in height.

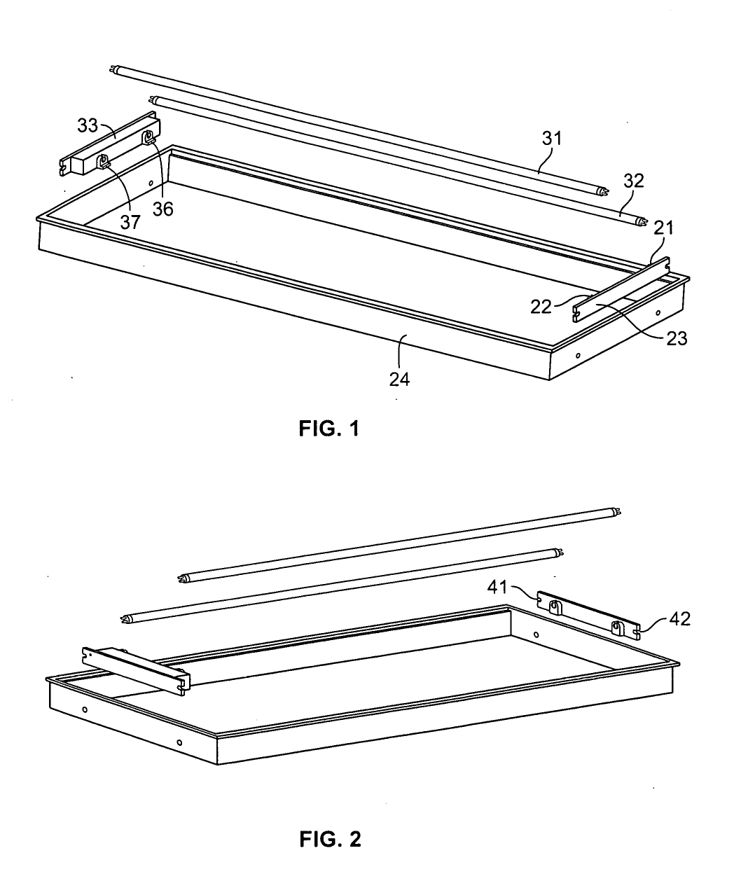

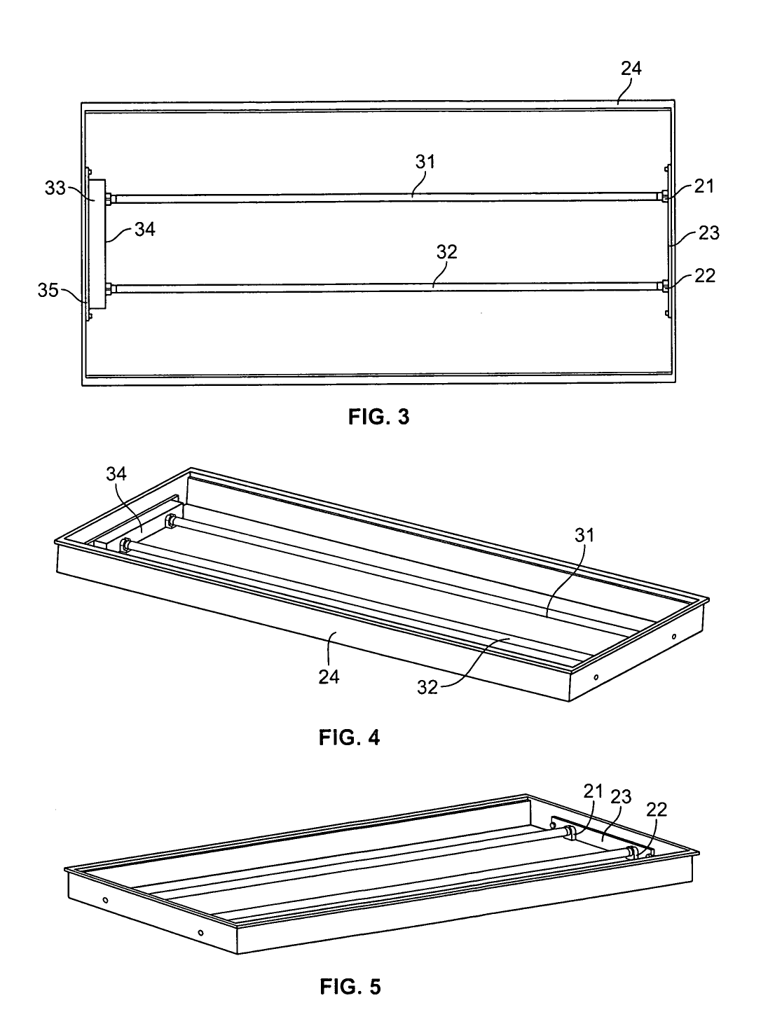

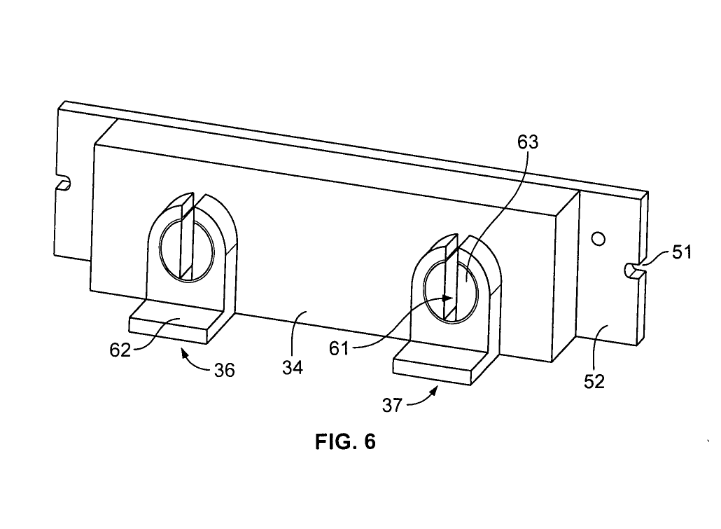

FIG. 1 shows an exploded view of the present invention with the first bulb 31 and second bulb 32 removed from the reflector 24. The first bulb 31 and second bulb 32 install into the reflector between an intermediate connector 23 and a ballast 33. The intermediate connector 23 is formed as a plate, such as one made of a sheet of metal or plastic. The intermediate connector 23 includes a first socket base connector 21 and the second socket base connector 22. The first socket base connector 21 is directly electrically connected to the second socket base connector 22 so that the first bulb and the second bulb are in electrical series.

The first bulb and second bulb are electrically connected to the ballast 33. The ballast 33 has a ballast top face 34 facing the first bulb and the second bulb. The ballast top face 34 includes a first ballast top face socket 36 and a second ballast top face socket 37. The ballast has internal electrical components mounted to either the top housing of the ballast or the bottom housing of the ballast. The top housing of the ballast meets with the bottom housing of the ballast to encapsulate the internal electrical components within the ballast.

The second figure shows an alternate view of the exploded view of the present invention. The ballast is made of a housing having a top and bottom. The top portion has a top face 34 and the bottom portion has the ballast bottom face 35. The final construction of the ballast is turned 90° and mounted with the bottom facing the sidewall of the reflector and with the ballast sockets facing the intermediate connector sockets. It is preferred that the ballast sockets, namely a first ballast top face socket 36 and a second ballast top face socket 37, are mounted to the outside of the ballast top face 34. Wire connections pass from the ballast sockets through the ballast top face in to internal components inside the ballast housing.

The top portion of the ballast fits together with the bottom portion of the ballast. The top portion comprises a housing section that is preferably connected to the bottom portion of the ballast which also comprises a housing section for the ballast. Electronic components are housed within the ballast. In the current configuration of the ballast, the ballast is unique in that no output wires extend from the ballast. The ballast preferably does not have any wires required for output, but receives input from a pair of power wires. The ballast may have connection of input wires including the neutral wire, the hot wire and the ground wire.

The intermediate connector 23 may have a pair of wires passing from the first socket connector to the second socket connector so as to connect the first socket connector and the second socket connector in series. The first socket connector and the second socket connector preferably clip on to the planar body of the intermediate connector 23. The intermediate connector 23 planar body is preferably made of a stamped sheet of metal that can be folded into a strip with a pair of ends, namely a first end and a second end. The first socket connector is connected at the first end and the second socket connector is connected at the second end. The intermediate connector 23 may have a pair of notched portions at each of its first end second end. The first end can have the first notch and the second end can have a second notch. The first notch 41 may receive a first bolt and the second notch 42 may receive a second bolt. In the preferred embodiment, the intermediate connector 23 is bolted to a sidewall of the reflector housing.

The reflector generally has a flat profile, or low-profile. The length of the reflector is equivalent to the sum of the length of the light bulb tubes, the ballast, the ballast sockets, the intermediate connector, the intermediate connector sockets and the thickness of the sidewalls of the reflector. The reflector preferably has a reflective coating or reflective sheet disposed within to reflect light from the first bulb and the second bulb. The reflector reflecting surface can be formed of a polished sheet of aluminum.

The ballast 33 can be placed to abut an inside surface of the reflector. Also, the intermediate connector can be sized so that it abuts the inside surface of the reflector. The intermediate connector preferably has the shape of a rail for snap in connection to the reflector. The ballast 33 also preferably has a snap in connection to the reflector. The ballast 33 also preferably has a bolt connection to the reflector. The ballast may also include a ballast notch 51 for bolt connection. The ballast notch 51 is preferably disposed on the lower portion of the ballast on a ballast flange 52 that extends from the ballast bottom face 35.

As shown in FIG. 6, the ballast 33 has a ballast top face 34 upon which are mounted a pair of ballast sockets. Each of the ballast sockets further includes a ballast to socket slot 61 and a ballast socket housing 62. The ballast socket slot 61 communicates with a ballast socket pivoting member 63. The ballast socket pivoting member rotates inside the ballast socket housing 62 so as to secure electrical leads of a lamp bulb within the pivoting member portion of the ballast socket slot.

Therefore, while the presently preferred form has been shown and described, it is to be understood that the present invention is not limited to the sole embodiment described above, but encompasses any and all embodiments within the scope of the following claims.

1. An end mounted ballast lighting fixture comprising:
a. a reflector, wherein the reflector is generally rectangular shaped;
b. a ballast mounted to the reflector wherein the ballast has a ballast housing comprising a pair of sections, namely a top ballast housing section and a lower ballast housing section, wherein the lower ballast housing section is mounted to a side wall of the reflector;
c. a pair of ballast sockets, namely a first ballast top face socket and a second ballast top face socket mounted on a top face of the top ballast housing section;
d. a pair of florescent light bulbs that are T5, namely a first florescent light bulb and a second florescent light bulb, wherein the top face faces toward the pair of florescent light bulbs, wherein the first florescent light bulb is electrically connected to the first ballast top face socket, and wherein the second florescent light bulb is electrically connected to the second ballast top face socket, wherein the ballast and ballast sockets are approximately 2 inches high measured in a direction of a length of the bulb;
e. an intermediate connector formed as a flat strip having a first end and a second end; and
f. a pair of electrically connected socket connectors, namely a first socket connector, and a second socket connector both attached to the intermediate connector, wherein the first socket connector and the second socket connector are connected in electrical series.

2. The end mounted ballast lighting fixture of claim 1, wherein the ballast is placed to abut an inside surface of the reflector.

3. The end mounted ballast lighting fixture of claim 1, wherein the intermediate connector is mounted to abut the inside surface of the reflector.

4. The end mounted ballast lighting fixture of claim 1, wherein the ballast is configured to snap into an inside surface of the reflector.

5. The end mounted ballast lighting fixture of claim 1, wherein the intermediate connector has the shape of a flat rail for snap in connection to the reflector.

6. The end mounted ballast lighting fixture of claim 1, wherein a ballast notch is disposed on the lower portion of the ballast on a ballast flange that extends from the ballast bottom face.

7. The end mounted ballast lighting fixture of claim 1, wherein the pair of ballast sockets each further include a ballast socket slot and a ballast socket housing, wherein the ballast socket slot communicates with a ballast socket pivoting member that rotates inside the ballast socket housing so as to secure electrical leads of a lamp bulb within the pivoting member portion.

8. The end mounted ballast lighting fixture of claim 1, wherein a ballast notch is disposed on the lower portion of the ballast on a ballast flange that extends from the ballast bottom face, wherein the pair of ballast sockets each further include a ballast socket slot and a ballast socket housing, wherein the ballast socket slot communicates with a ballast socket pivoting member that rotates inside the ballast socket housing so as to secure electrical leads of a lamp bulb within the pivoting member portion.

9. The end mounted ballast lighting fixture of claim 8, wherein the ballast is placed to abut an inside surface of the reflector.

10. The end mounted ballast lighting fixture of claim 8, wherein the intermediate connector is mounted to abut the inside surface of the reflector.

11. The end mounted ballast lighting fixture of claim 8, wherein the ballast is configured to snap into an inside surface of the reflector.

12. The end mounted ballast lighting fixture of claim 8, wherein the intermediate connector has the shape of a flat rail for snap in connection to the reflector.

13. The end mounted ballast lighting fixture of claim 1, wherein the ballast is configured to snap into an inside surface of the reflector, wherein the intermediate connector has the shape of a flat rail for snap in connection to the reflector.

14. The end mounted ballast lighting fixture of claim 13, wherein a ballast notch is disposed on the lower portion of the ballast on a ballast flange that extends from the ballast bottom face.

15. The end mounted ballast lighting fixture of claim 13, wherein the pair of ballast sockets each further include a ballast socket slot and a ballast socket housing, wherein the ballast socket slot communicates with a ballast socket pivoting member that rotates inside the ballast socket housing so as to secure electrical leads of a lamp bulb within the pivoting member portion.
